(19) United States
(12) Patent Application Publication
(10) Pub. No.: US 2013/0069617 A1
(43) Pub. Date: Mar. 21, 2013

(54) POWER ADAPTER

(71) Applicant: CHUNG-EN LEE, Kaohsiung City (TW)

(72) Inventor: CHUNG-EN LEE, Kaohsiung City (TW)

(73) Assignees: LITE-ON TECHNOLOGY CORPORATION, TAIPEI CITY (TW); SILITEK ELECTRONIC (GUANGZHOU) CO., LTD., GUANGZHOU (CN)

(21) Appl. No.: 13/329,269

(22) Filed: Dec. 17, 2011

(30) Foreign Application Priority Data
Sep. 16, 2011 (CN) 201120346594.3

(51) Int. Cl. H02J 3/00

(52) U.S. Cl. 323/318

(57) ABSTRACT

A power adapter comprises a microprocessor, a wireless communication module, a relay, a circuit board, a casing, a power input end, and a power output end. The microprocessor generates a switching signal according to a wireless control signal. The wireless communication module receives the wireless control signal and transmits the wireless control signal to the microprocessor. An input end of the relay electrically coupled to the power input end receives an alternative current (AC) power, and a control end of the relay electrically coupled to the microprocessor receives the switching signal. The relay outputs the AC power from the input end to the output end of the relay electrically coupled to the power output end according to the switching signal. The structure of the power input end corresponds to a power outlet. The structure of the power output end corresponds to a power plug of an electrical appliance.

### BACKGROUND

1. Technical Field

The present disclosure relates to a power adapter, and more particularly to a power adapter which is controlled by a wireless controller to output the received power, wherein the power adapter is connected between a power plug of an electrical appliance and a power outlet.

2. Description of Related Art

In everyday life, most electrical appliances in the non-operated state do not automatically power off themself, but showing the standby state. However, even if the appliance is not operated, the appliance would still cause a power loss. For example, when the air conditioner is not operated, the air conditioner remains with the average standby power of 10 W. When the washing machine is not operated, the also washing machine remains with the average standby power of 2 W.

In addition, many environmental groups strongly advocate of carbon reduction and power saving, and the environmental trend encourages people to pull out the power plug of the non-operated electrical appliance from the power outlet, in order to reduce energy loss and destruction of the Earth's environment. However, it is not easy for people to readily develop the habit of pulling out the power plug of the non-operated electrical appliance usually, and the unplugged plugs may be disordered and ugly. Accordingly, a power adapter or an electrical appliance provided by the current industrial can set the automatic power-off time. When the automatic power-off time set by the power adapter or the electrical appliance has been reached, the power adapter or the electrical appliance automatically powers off, and the power is not provided to the electrical appliance automatically to the connected electrical device.

However, there are electrical appliances of dozens kinds in the surrounding environment. If the user wants to set the automatic power-off time of each electrical appliance, the user must do the dozen setting actions, which brings the extreme inconvenience to the user.

### SUMMARY

An exemplary embodiment of the present disclosure provides a power adapter comprising a microprocessor, a wireless communication module, a relay, a circuit board, a casing, a power input end, and a power output end, wherein the microprocessor, the wireless communication module, and the relay are disposed on the circuit board. The casing has a first opening and a second opening, and the casing is used to cover the circuit board. The power input end is disposed on the circuit board, protruding the first opening, and electrically coupled to the relay. The power output end is disposed on the circuit board, protruding the second opening, and electrically coupled to the output end of the relay. The microprocessor generates a switching signal according to a wireless control signal. The wireless communication module electrically coupled to the microprocessor receives the wireless control signal, and transmits the wireless control signal to the microprocessor. The relay has an input end, an output end, and a control end. The input end is used to receive alternative current (AC) power, the control end is electrically coupled to the microprocessor, the control end is used to receive the switching signal, and the relay outputs the AC power from the input end to the output end according to the switching signal. A structure of the power input end is corresponding to a power outlet, so as to receive the AC power and transmit the AC power to the input end of the relay. A structure of the power output end is corresponding to a power plug of an electrical appliance, so as to output the AC power the electrical appliance through the power adapter.

To sum up, the power adapter provided by the exemplary embodiment of the present disclosure has the wireless communication module for receiving the wireless control signal and generating the switching signal correspondingly, wherein the switching signal determines whether the AC power is output to the electrical appliance connected to the power adapter. Thus, the user can turn on/off the power of the electrical appliance connected to the power adapter immediately or at fixed time. In other words, the user can use the wireless controller to control the power adapter not to output the AC power to the electrical appliance, such that the electrical appliance is turned off. While the electrical appliance without being turned off by a wireless or automatic control is connecting to the power adapter, the electrical appliance can be turned off by a wireless or automatic control. Meanwhile, the user has not to pull out the plug of the electrical appliance. Thus, the power adapter can let the user achieve the power saving easily. After the electrical appliance without being turned off by a wireless or automatic control is connecting to the power adapter the user can use the wireless controller to turn on/off the electrical appliance.

In order to further understand the techniques, means and effects the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a block diagram of a power adapter according to an exemplary embodiment of the present disclosure.

FIG. 2A and FIG. 2B are three-dimensional diagrams of the power adapter in FIG. 1 with different observation angles.

FIG. 2C is a front view diagram of the power adapter provided in FIG. 1.

FIG. 3A and FIG. 3B are schematic diagram showing the usage of the rotatable timing button of the power adapter in FIG. 2A.

FIG. 4 is a block diagram of a power adapter according to another exemplary embodiment of the present disclosure.

FIG. 5A and FIG. 5B are three-dimensional diagrams of the power adapter in FIG. 4 with different observation angles.

FIG. 6 is a three-dimensional diagram of the power adapter according to another exemplary embodiment of the present disclosure.

FIG. 7 is an explosive diagram of the power adapter according to another exemplary embodiment of the present disclosure.

FIG. 8 is a three-dimensional diagram of a power output end according to another exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

[Exemplary Embodiment of Power Adapter]

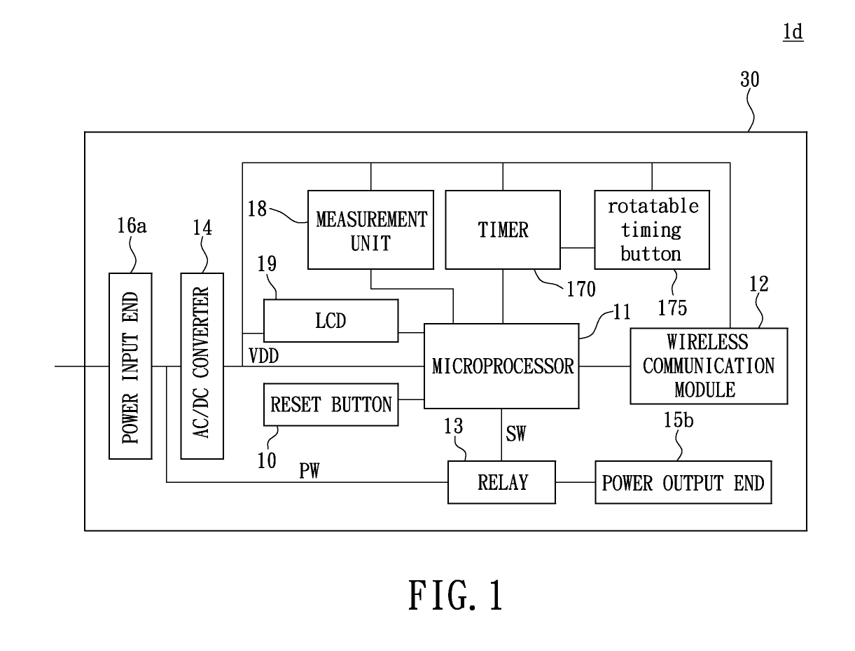

Referring to FIG. 1, FIG. 1 is a block diagram of a power adapter according to an exemplary embodiment of the present disclosure. The power adapter 1d comprises a microprocessor 11, a wireless communication module 12, a relay 13, an alternative current/direct current (AC/DC) converter 14, a power output end 15b, a power input end 16a, a timer 170, a rotatable timing button 175, a measurement unit 18a liquid crystal display (LCD) 19, and a reset button 10. The microprocessor 11 is electrically coupled to the supplying power VDD, a wireless communication module 12, and a relay 13. An input end of the relay 13 input end is electrically coupled to an AC power PW, a control end of the relay 13 is electrically coupled the microprocessor 11, and an output end of the relay 13 is electrically coupled to an external electrical device (not shown in FIG. 1). The timer 170, the measurement unit 18, the LCD 19, and the reset button 10 are electrically coupled to the microprocessor 11, and the rotatable timing button 175 is electrically coupled to the timer 170.

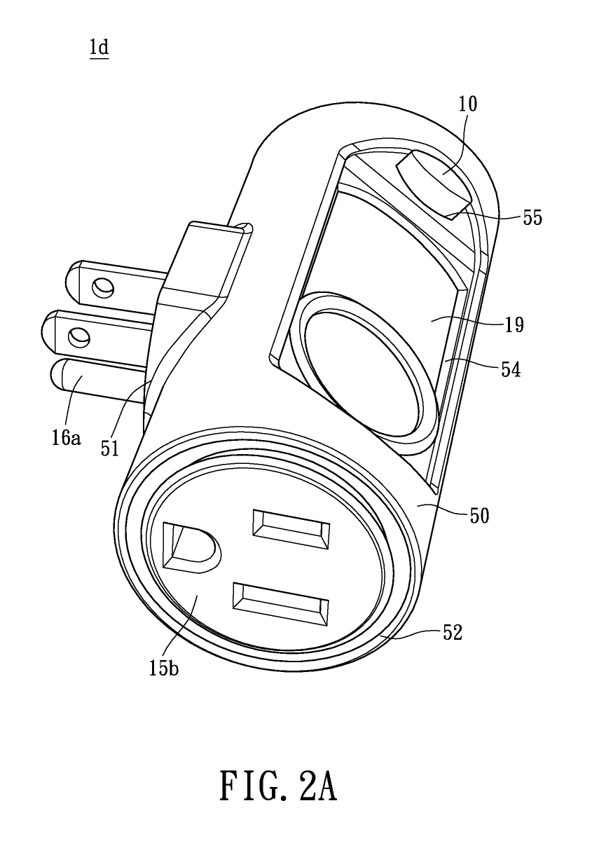

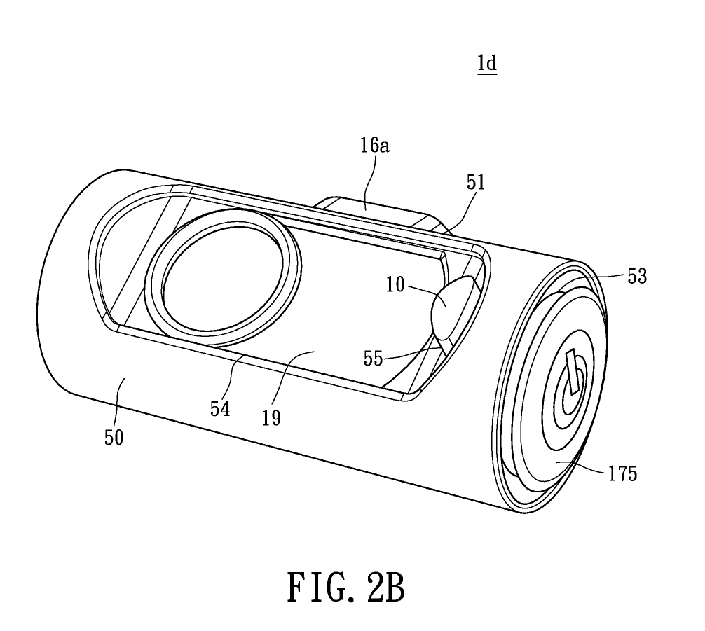

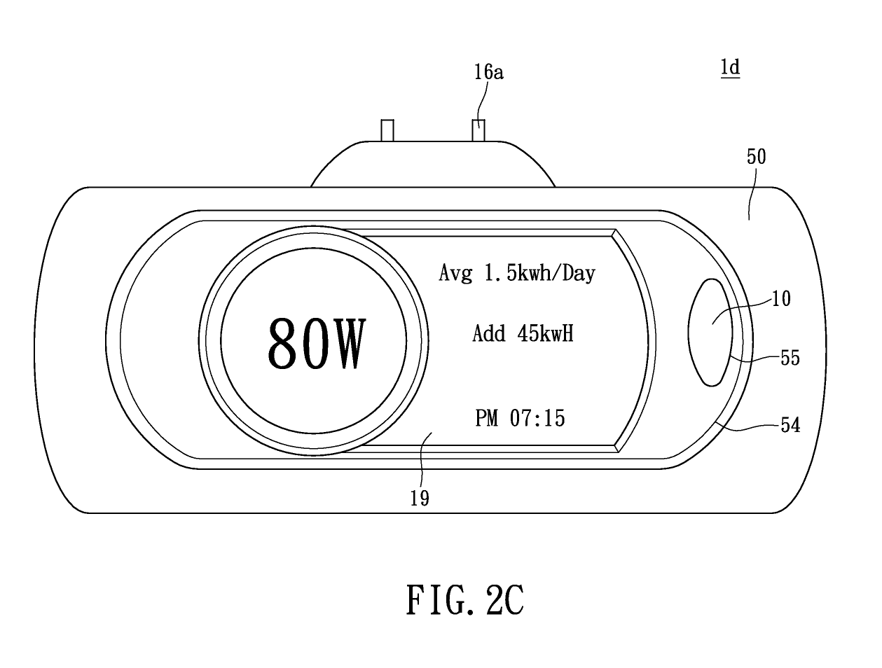

The power adapter 1d further has a circuit board 30, wherein the microprocessor 11, the wireless communication module 12, the relay 13, the timer 170, and the measurement unit 18 are disposed on the circuit board 30. The power adapter 1d further has a casing 50 (shown in FIG. 2. The casing 50 covers the circuit board 30, and has a plurality of openings. The power input end 16a is disposed on the circuit board 30, protruding one of the openings of the casing 50, and electrically coupled to the relay 13. The power output end 15b is disposed on circuit board 30 and protruding another one of the openings of casing 50. The power output end 15b is electrically coupled to the output end of the relay 13.

The wireless communication module 12 receives the wireless control signal, and transmits the wireless control signal to the microprocessor 11. In other words, the user can use a wireless controller to generate a wireless control signal to the wireless communication module 12 through the wireless channel. It is noted that the wireless communication module 12 substantially adopts the ZigBee protocol as the wireless network protocol.

However, the kinds and types of the wireless network protocol are not used to limit the present disclosure. For example, the wireless communication module 12 can adopt the wireless network protocol of Wi-Fi or Bluetooth. The ZigBee protocol has the property of low power consumption. To achieve the power saving, the wireless communication module 12 is preferred to be the ZigBee wireless communication module, and the wireless controller is preferred to be the ZigBee wireless controller.

The microprocessor 11 generates the switching signal SW according to the wireless control signal, and the relay 13 receives the switching signal SW of generated by the microprocessor 11. The relay 13 outputs the AC power PW from the input end thereof to the output end thereof according to the switching signal SW.

In the exemplary embodiment of the present disclosure, the relay 13 can be an electrical switch in the current market, for example, an electromagnetic relay, a sensing relay, an electrical relay, a solid state relay (SSR) or the other transistors having the switching functions. It is noted that the type and the switching mean of the relay 13 are not used to limit the present disclosure.

In short, when the user uses the wireless controller (not shown in FIG. 1) to generate the wireless control signal to the power adapter 1d, the wireless communication module 12 of the power adapter 1d receives the wireless control signal, and transmits the wireless control signal to the microprocessor 11. The microprocessor 11 generates the switching signal SW according to the wireless control signal, and transmits the switching signal SW to the control end of the relay 13. The relay 13 outputs the AC power PW from the input end thereof to the output end thereof according to the switching signal SW.

The AC/DC converter 14 is electrically coupled to the household power outlet through the power input end 16a to receive the AC power, wherein the power input end 16a is for example a household power plug. The AC/DC converter 14 converts the AC power PW to the DC power. The supplying power VDD of the microprocessor 11, the wireless communication module 12, the timer 170, and the measurement unit 18, and the LCD 19 is the DC power to which the AC/DC converter 14 converts the AC power PW. In the exemplary embodiment, AC/DC converter 14 can be the currently and popularly marketed AC/DC converter, for example, a bridge rectifier, a three phase pulse width modulation (PWM) rectifier, a voltage doubling rectifier, or an inverter.

The power output at the output end of the relay 13 is the AC power, the electrical device electrically coupled to the power output end 15b of the power adapter 1d is the AC electrical appliance, and the power output end 15b is the AC power outlet or the AC power output end of the other type. Thus, the power adapter 1d in FIG. 1 is used to connect the AC electrical appliance to the household power outlet.

In the exemplary embodiment, the timer 170 is used to set the on/off time of the power adapter 1d by the user's operation, wherein the on/off time can be the turned on time or the turned off time. When the on/off time has been reached, the microprocessor 11 generates the switching signal SW to the relay 13. That is, the microprocessor 11 generates the switching signal SW according to the on/off time, and then transmits the switching signal SW to the relay 13. Next, the relay 13 outputs the AC power PW from the input end thereof to the output end thereof according to the switching signal SW.

In the exemplary embodiment, the rotatable timing button 175 is served as an operating interface between the user and the timer, wherein the user rotates the rotatable timing button 175 to set the on/off time. For example, when the user wants to turn off the AC electrical appliance connected to the power adapter 1d at 5:15 in the afternoon, the user can pull out the rotatable timing button 175, and then rotate the rotatable timing button 175 to set the turned off time to be PM 5:15. Thus, the microprocessor 11 generates the corresponding switching signal SW when the turned off time has been reached.

However, it is noted that the manner using the rotatable timing button 175 as the operating interface to set the on/off time of the timer 170 is not used to limit the present disclosure. In FIG. 1, the user can also use the wireless controller to transmit the wireless control signal to the wireless communication module 12, and then the wireless communication module 12 can transmit the wireless control signal to the microprocessor 11, such that the microprocessor 11 can set the on/off time of the timer 170. In other words, the on/off time of the timer 170 can be wirelessly set.

The measurement unit 18 is used to calculate the electricity consumption information of the external electrical device. For example, when the power adapter 1d outputs the AC power PW to the external electrical device, the measurement unit 18 can calculate the current power consumption, the average power consumption, and the total power consumption of the external electrical device.

In addition, in the exemplary embodiment, the measurement unit 18 is substantially a power meter. However, it is noted the measurement unit 18 can further be a voltage meter, a current meter, or an electricity calculation chip of any type. In short, the circuit design and the chip type of the measurement unit 18 are not used to limit the present disclosure.

In the exemplary embodiment, the LCD 19 is used to display the electricity consumption information of the external electrical device and the on/off time associated to the power adapter 1d. To put it concretely, the measurement unit 18 transmits the electricity consumption information to the LCD 19 through the microprocessor 11, such that the LCD 19 displays the electricity consumption information to the user. In addition, if the user sets the on/off time of the timer 170, the on/off time will be transmitted to LCD 19 through the microprocessor 11 to display the on/off time. For example, if the turned off time of the timer 170 is set to be PM 5:15, the turned off time will be displayed by the LCD 19, such that the user can see the turned off time is PM 5:15.

The user can press or push the reset button 10 to reset the measurement unit 18, such that the measurement unit 18 can re-calculate the electricity consumption information. That is, the electricity consumption information can be re-calculated, and the re-calculated electricity consumption information is displayed on the LCD 19, while the reset button 10 is pressed to reset the measurement unit 18.

The power input end 16a can be the household power plug, and the household power plug is a male connector having blades or copper protruding portions. The power input end 16a can be physically plugged into the household power outlet which is a female connector, wherein the female connector has slots or holes. Generally, the household power plug has a live fire connector (corresponding to the hole with a shorter aperture), a neutral wire connector (corresponding to the hole with a longer aperture), and some household power plug further has a ground wire connector (corresponding to the middle hole). Regarding most household power plugs, the live wire connector is not distinguish from the neutral wire connector, but some household power plug may have a plurality of live wires. The household power plug may be coated with the copper, tin, nickel, or their combination.

The power output end 15b can be the household power outlet, and the household power outlet is a female connector having holes or slots. The household plug of the AC electrical appliance can plug to the female connector, so as to transmit the AC power to the AC electrical appliance through the household plug and the power output end 15b, wherein the household plug of the AC electrical appliance is the male connector having blades or copper protruding portions. In the most countries, the household power is the single phase power. Thus, the electricity of the household power is transmitted to the AC electrical appliance through one conductive wire (the live wire), and the electricity in the AC electrical appliance is returned to the household power through another one conductive wire (the neutral wire). In addition, many household power plugs and outlets further have the third connector (ground wire connector), and the third connector is used to connect the AC electrical appliance to the earth, therefore preventing from the damage of the user and the AC electrical appliance due to the electricity leakage.

In the exemplary embodiment of FIG. 1, when the power input end 16a is plugged into the corresponding household power outlet, the live wire and the neutral wire of the power input end 16a are electrically coupled to the household power. When the household plug of the AC electrical appliance is plugged into the power output end 15b, the live wire and the neutral wire of the household plug of the AC electrical appliance are electrically coupled to the power output end 15b, such that the electricity of the household power (i.e. AC power) is transmitted to the AC electrical appliance through the power adapter 1d.

Referring to FIG. 2A through FIG. 2C, FIG. 2A and FIG. 2B are three-dimensional diagrams of the power adapter in FIG. 1 with different observation angles, and FIG. 2C is front view diagram of the power adapter provided in FIG. 1. In FIG. 2A through FIG. 2C, the casing 50 of the power adapter 1d has a plurality of openings 51 through 55, and the power input end 16a, the power output end 15b, the rotatable timing button 175, the LCD19, and the reset button 10 are protruding the openings 51 through 55 respectively.

In addition, in the exemplary embodiment of FIG. 2C, the LCD 19 displays the current power consumption of the external electrical device, and the current power consumption is 80 watts. Furthermore, the LCD 19 further displays the average power consumption of 1.5 kilowatts/day, the total power consumption of 45 kilowatts-hours, the turned off time of PM 7:15.

It is noted that, in the exemplary embodiment of FIG. 2A through FIG. 2C, the power input end 16a and the power output end 15b are respectively the B-type household plug and the B-type household outlet. However, it is noted that the types of the power input end 16a and the power output end 15b are not used to limit the present disclosure.

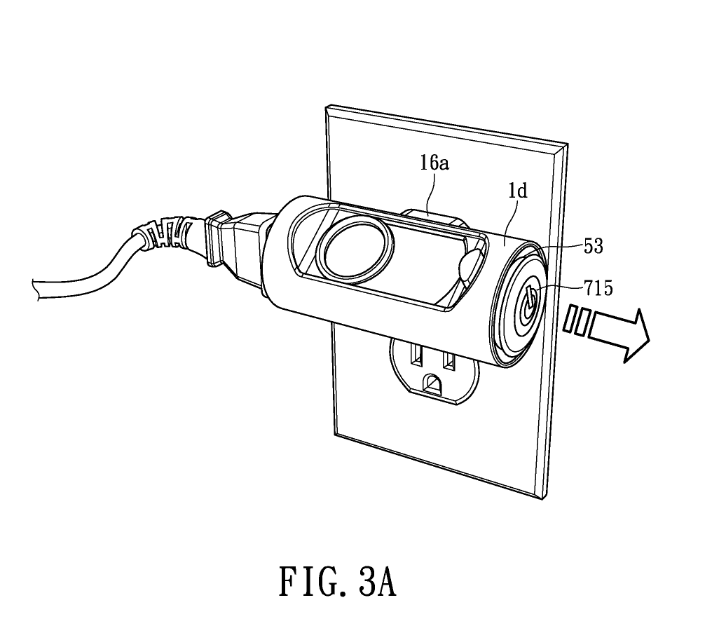

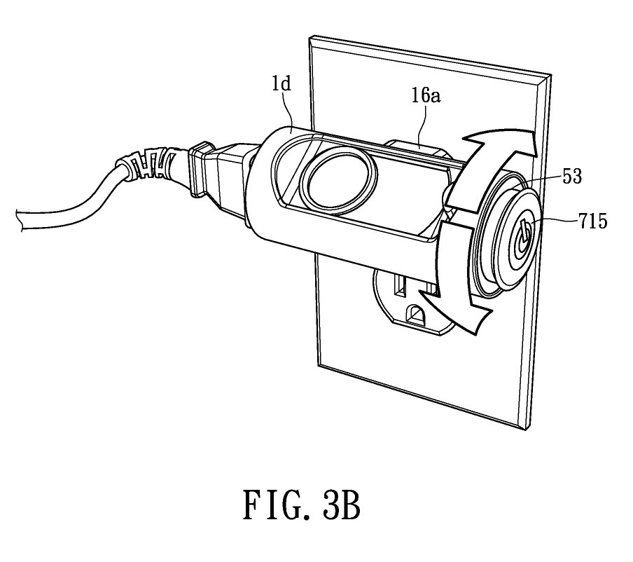

Referring to FIG. 3A and FIG. 3B, FIG. 3A and FIG. 3B are schematic diagram showing the usage of the rotatable timing button of the power adapter in FIG. 2A. In FIG. 3A and FIG. 3B, the power output end 15b is electrically coupled to the AC electrical appliance, and the power input end 16a is electrically coupled to the household power outlet on the wall or on the extension cord apparatus. When the user want to set the on/off time of the power adapter 1d, the user can pull out the rotatable timing button 715 along with an outward direction of the opening 53, wherein the outward direction of the opening 53 is shown by the arrow direction of FIG. 3A. Next, the user can rotate the rotatable timing button 715 to set on/off time. Then, after the user has rotated the rotatable timing button 715 to set on/off time, the user can push the rotatable timing button 715 along with an inward direction of the opening 53 (opposite to the outward direction of the opening 53), thus completing the setting of the on/off time, wherein the inward direction of the opening 53 is shown by the arrow direction of FIG. 3A.

It is noted that, the power output end 15b can be the B-type household power outlet. The B-type household power outlet allows the A-type of B-type power plug to plug thereto, and thus in FIG. 3A and FIG. 3B, the power outlet of the AC electrical appliance is the A-type household power outlet.

[Another Exemplary Embodiment of Power Adapter]

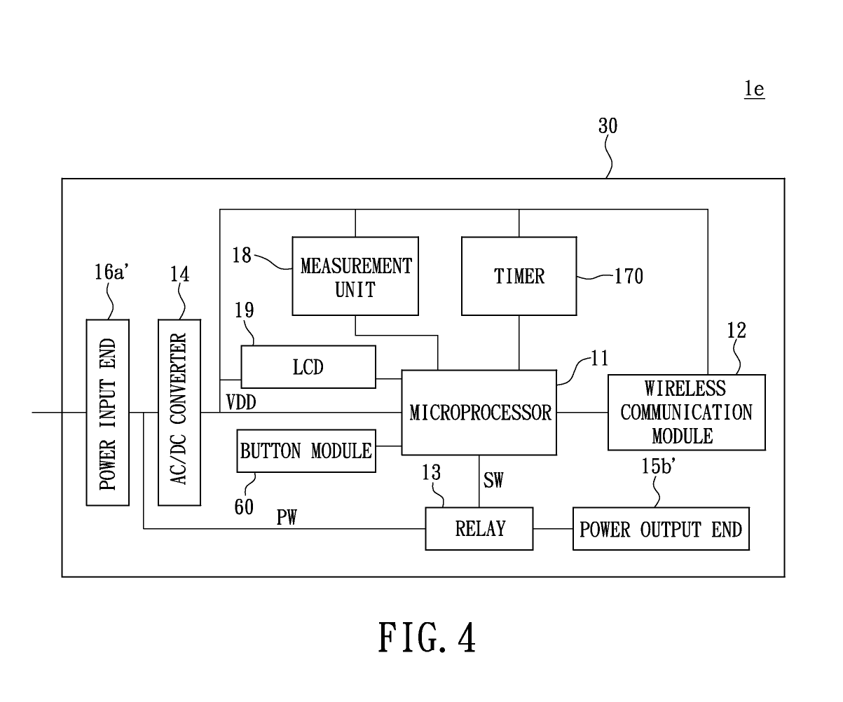

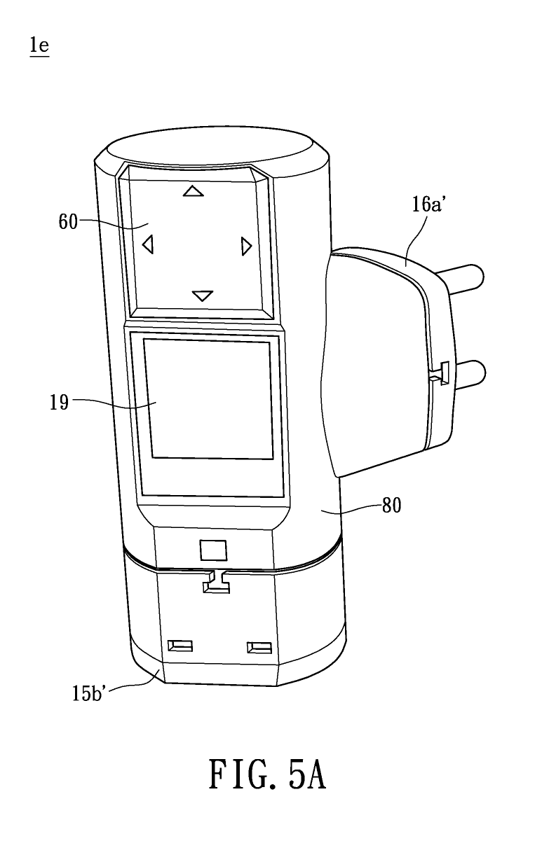

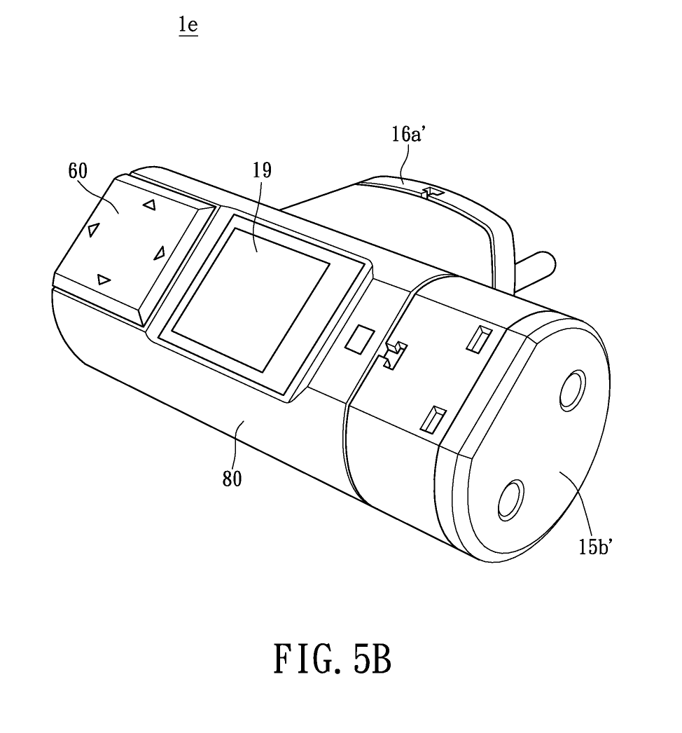

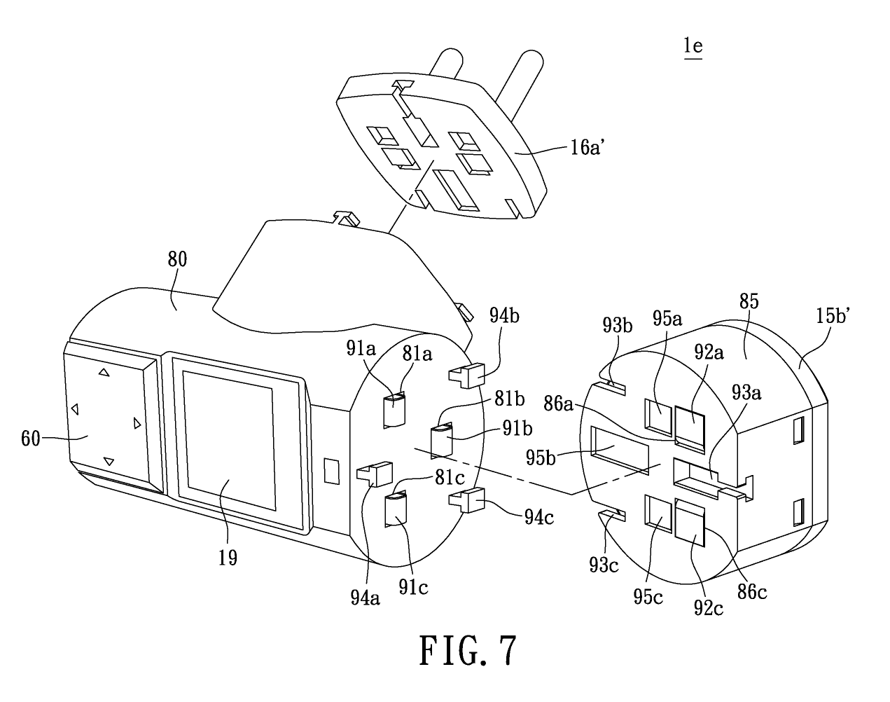

Referring to FIG. 4, FIG. 4 is a block diagram of a power adapter according to another exemplary embodiment of the present disclosure. The power adapter 1e in FIG. 4 is similar to the power adapter 1d in FIG. 1, and the difference is stated as follows. The power adapter 1e in FIG. 7 has a button module 60, but the power adapter 1d in FIG. 1 has the reset button 10. Referring to FIG. 5A and FIG. 5B, FIG. 5A and FIG. 5B are three-dimensional diagrams of the power adapter in FIG. 4 with different observation angles. In the exemplary embodiment, the button module 60 comprises the up, down, right, left direction buttons, and the button module 60 can be programmed to have the function of the reset button while a specific inputting manner is operated.

It is noted that, the power input end 16a′ and the power output end 15b′ in the power adapter 1e are not disposed on and protruding the opening of the casing 80. In the exemplary embodiment, the casing 80 is designed to let the user to remove power input end 16a′ and the power output end 15b′ from the casing, and to install the power input end 16a′ and the power output end 15b′ on the casing. Furthermore, the casing 80 does not cover the power input end 16a′ and the power output end 15b.

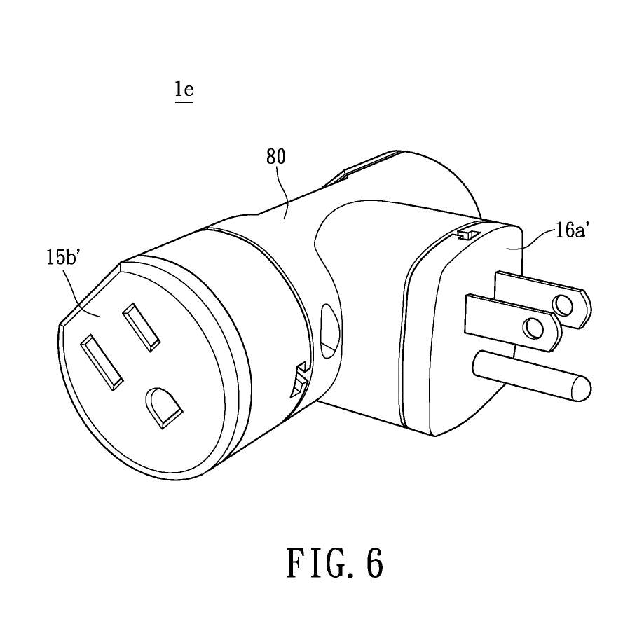

Referring to FIG. 6, FIG. 6 is a three-dimensional diagram of the power adapter according to another exemplary embodiment of the present disclosure. The type of the power input end 16a′ in FIG. 5A (or FIG. 5B) is not the same as the type of the power input end 16a′ in FIG. 6. In the same manner, the type of the power output end 15b′ in FIG. 5A (or FIG. 5B) is not the same as the type of the power output end 15b′ in FIG. 6. To put it concretely, in FIG. 5A (or FIG. 5B), the power output end 15b′ and the power input end 16a′ are respectively C-type household power outlet and C-type household power plug, but in FIG. 6, the power output end 15b′ and the power input end 16a′ are respectively B-type household power outlet and B-type household power plug.

Referring to FIG. 7, FIG. 7 is an explosive diagram of the power adapter according to another exemplary embodiment of the present disclosure. The structure of the power input end 16a′ is similar to the structure of the power output end 15b′. Though merely the structure of the power output end 15b′ is illustrated, the structure of the power input end 16a′ can be known according to the illustration of the structure of the power output end 15b′. The power output end 15b′ has the casing 85, the conducting sheets 92a and 92c are disposed on the openings 86a and 86c of the casing 85, and the conducting sheets 91a and 91c corresponding to the conducting sheets 92a and 92c are disposed on the openings 81a and 81c of the casing 80 of the power adapter 1e. To adopt the power output end 15b′ of the different type, the conducting sheet 91b on the center line between the conducting sheets 91a and 91c is disposed on the opening 81b of the casing 80 of the power adapter 1e.

When the user wants to install the power output end 15b′, the user may places the T-shaped fixing part 94a in the accommodation space of the ditch 93a, and at the same time, the conducting sheets 91a through 91c can be correspondingly placed in the accommodation spaces 95a through 95c. Next, the user slides the power output end 15b′ to fix the T-shaped fixing parts 94a through 94c respectively in the ditches 93a through 93c, such that the conducting sheets 91a and t91c are moved respectively from the accommodation spaces 95a and 95c to connect the conducting sheets 92a and 92c. In addition, when the user wants to remove the power output end 15b′, the user can do the inversed operation mentioned above to remove the power output end 15b′ from the casing.

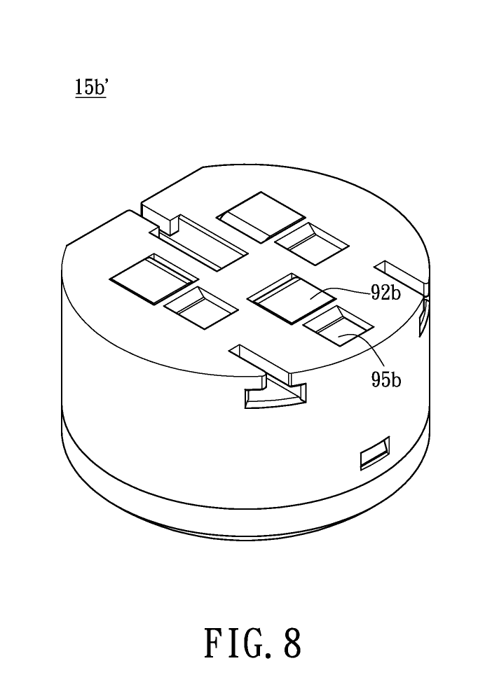

Referring to FIG. 8, FIG. 8 is a three-dimensional diagram of a power output end according to another exemplary embodiment of the present disclosure. The type of the power output end 15b′ in FIG. 7 is not same as the type of the power output end 15b′ in FIG. 8. The power output end 15b′ is in FIG. 8 is the B-type household power outlet, thus the power output end 15b′ in FIG. 8 further has the conducting sheet 92b served as the ground wire, and the accommodation space 95b is correspondingly smaller than that in FIG. 7. The manner for installing or removing the power output end 15b′ in FIG. 8 is the same as the manner mention above.

In order to further understand the techniques, means and effects the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

What is claimed is:

1. A power adapter, comprising:
a microprocessor, used to generate a switching signal according to a wireless control signal;
a wireless communication module, electrically coupled to the microprocessor, used to receive the wireless control signal, and transmit the wireless control signal to the microprocessor;
a relay, having an input end, an output end, and a control end, wherein the input end is used to receive an alternative current (AC) power, the control end is electrically coupled to the microprocessor, the control end is used to receive the switching signal, and the relay outputs the AC power from the input end to the output end according to the switching signal;
a circuit board, wherein the microprocessor, the wireless communication module, and the relay are disposed on the circuit board;
a casing, having a first opening and a second opening, wherein the casing is used to cover the circuit board;
a power input end, disposed on the circuit board, protruding the first opening, electrically coupled to the relay, wherein a structure of the power input end is corresponding to a power outlet, so as to receive the AC power and transmit the AC power to the input end of the relay; and
a power output end, disposed on the circuit board, corresponding to the second opening, electrically coupled to the output end of the relay, wherein a structure of the power output end is corresponding to a power plug of an electrical appliance, so as to output the AC power to the electrical appliance through the power adapter.

2. The power adapter according to claim 1, further comprising:
a timer, electrically coupled to the microprocessor, disposed on the circuit board, used to set an on/off time by a user,
wherein the microprocessor generates the switching signal according to the on/off time and then transmits the switching signal to the relay, and the relay thus outputs the AC power from the input end to the output end according to the switching signal.

3. The power adapter according to claim 2, wherein the user indicates the microprocessor to set the on/off time of the timer through the wireless control signal, and when the on/off time has been reached, the timer indicate the microprocessor to generate the switching signaling to the relay, such that the relay thus outputs the AC power from the input end to the output end according to the switching signal.

4. The power adapter according to claim 2, wherein the casing further has a third opening, and the power adapter further comprises:
a rotatable timing button, disposed on the third opening, electrically coupled to the timer, being served as an operating interface between the user and timer, wherein the user rotates the rotatable timing button set the on/off time.

5. The power adapter according to claim 4, wherein the user pulls the rotatable timing button along with an outward direction of the third opening, such that the user is allowed to rotate the rotatable timing button to set the on/off time, and after finishing the use of the rotatable timing button, the user pushes the rotatable timing button along with an inward direction of the third opening, such that the rotatable timing button is fixed on the third opening.

6. The power adapter according to claim 4, further comprising:
a measurement unit, electrically coupled to the microprocessor, disposed on the circuit board, used to calculate an electricity consumption information.

7. The power adapter according to claim 6, wherein the casing further has a fourth opening, and the power adapter further comprises:
a liquid crystal display (LCD), disposed on the fourth opening, electrically coupled to the microprocessor, used to display the electricity consumption information.

8. The power adapter according to claim 6, wherein the casing further has a fifth opening, and the power adapter further comprises:
a reset button, deposed on the fifth opening, electrically coupled to the microprocessor, wherein the user pushes or presses the reset button to reset measurement unit, such that the measurement unit re-calculates the electricity consumption information.

9. The power adapter according to claim 1, wherein the wireless communication module is a ZigBee wireless communication module.

10. A power adapter, comprising:
a microprocessor, used to generate a switching signal according to a wireless control signal;
a wireless communication module, electrically coupled to the microprocessor, used to receive the wireless control signal, and transmit the wireless control signal to the microprocessor;
a relay, having an input end, an output end, and a control end, wherein the input end is used to receive an alternative current (AC) power, the control end is electrically coupled to the microprocessor, the control end is used to receive the switching signal, and the relay outputs the AC power from the input end to the output end according to the switching signal;
a circuit board, wherein the microprocessor, the wireless communication module, and the relay are disposed on the circuit board;
a first casing, used to cover the circuit board, wherein the first casing comprises a plurality of first openings, a plurality of second openings, a plurality of first T-shaped fixing parts, a plurality of second T-shaped fixing parts, a plurality of first conducting sheets disposed on the first openings, and a plurality of second first conducting sheets disposed on the second openings;
a removable power input end, a structure of the removable power input end is corresponding to a power outlet, the removable input end comprises a second casing, and the second casing comprises a plurality of third openings, a plurality of first accommodation spaces, a plurality of first ditches, and a plurality third conducting sheets disposed on the third openings, wherein the removable power input end is connected to the first casing through the first ditches, the first accommodation spaces, and the first T-shaped fixing parts, such that the third conducting sheets are electrically coupled to the first conducting sheets, and the removable power input end is electrically coupled to the relay to receive the AC power and transmit the AC power to the input end of the relay; and
a removable power output end, a structure of the removable power output end is corresponding to a power plug of an electrical appliance, the removable power output end comprises a third casing, the third casing comprises a plurality of fourth openings, a second accommodation spaces, a plurality of second ditches, and a plurality of fourth conducting sheets disposed on the fourth openings, wherein the removable power output end is connected to the first casing through the second ditches, the second accommodation spaces, and the second T-shaped fixing parts, such that the fourth conducting sheets are electrically coupled to the second conducting sheets, and the removable power output end is electrically coupled to the output end of the relay to transmit the AC power to the electrical appliance through the power adapter.
